(19) United States
(12) Patent Application Publication
(10) Pub. No.: US 2015/0352616 A1
(43) Pub. Date: Dec. 10, 2015

(54) SHAVING TOOL AND STEEL WIRE MATERIAL SHAVING METHOD USING SAME

(71) Applicant: KABUSHIKI KAISHA KOBE SEIKO SHO (KOBE STEEL, LTD.), Kobe-shi, Hyogo (JP)

(72) Inventor: Katsuhiko OZAKI, Kobe-shi (JP)

(73) Assignee: KABUSHIKI KAISHA KOBE SEIKO SHO (KOBE STEEL, LTD.), Hyogo (JP)

(21) Appl. No.: 14/760,376

(22) PCT Filed: Feb. 7, 2014
(86) PCT No.: PCT/JP2014/052972

§ 371 Date: Jul. 10, 2015

(30) Foreign Application Priority Data
Feb. 22, 2013 (JP) 2013-033204

(51) Int. Cl. B21C 43/04; B23D 79/12

(52) U.S. Cl. CPC B21C 43/04; B23D 79/12

(57) ABSTRACT

Provided is a shaving tool having a shaving die (2) for shaving a surface layer of a steel wire workpiece which is a material to be shaved, wherein a blade tip (2a) of the shaving die (2) is formed from any material from among a cemented carbide, a high speed tool steel, and a ceramic. In accordance with a specific shaving amount to be shaved from the surface layer of a steel wire material (1), the surface roughness of the steel wire material (1) allowable after shaving, and a specified life span required of the blade tip (2a), a rake angle (θ_{S}) of the blade tip (2a) is formed to be in the range of at least −30 degrees to no more than 0 degrees.

### TECHNICAL FIELD

The present invention relates to a shaving tool including a shaving die for shaving a surface layer of a steel wire material, and a steel wire material shaving method using the same.

### BACKGROUND ART

A defect such as a scale and a rolling mark remains on a surface layer of a wire material after finishing a hot rolling process, and an uneven part often exists on the surface. In order to smoothen such a surface of the wire material and improve surface quality, a processing method of shaving the surface layer of the wire material by using a shaving tool including a shaving die (shaving method) is adopted in general. As such a technique, techniques disclosed in Patent Documents 1, 2 are known.

In the technique disclosed in Patent Document 1, a plurality of jetting devices in which the directions of nozzles are adjustable is fixed at positions different from each other, and while jetting a cooling liquid from the plurality of jetting devices to a cutting edge of the shaving die, heat generation of the cutting edge is suppressed. Thereby, damage to the cutting edge of the shaving die is suppressed.

In the technique disclosed in Patent Document 2, in order to shave a relatively soft wire material of copper, a copper alloy, or the like, a cutting edge of the shaving die is made of powder high speed tool steel, and formed in such a manner that a rake angle of the cutting edge is 40 to 50 degrees, and a relief angle is 3 to 10 degrees.

### CITATION LIST

### Patent Document

Patent Document 1: JP 2007-283432 A
Patent Document 2: JP 5-228729 A

### SUMMARY OF THE INVENTION

### Problems to be Solved by the Invention

However, in the technique disclosed in Patent Document 1, there is a problem that a forced cooling device for cooling the cutting edge of the shaving die has to be installed and the technique is extremely troublesome.

The technique disclosed in Patent Document 2 is to shave the relatively soft wire material of copper, a copper alloy, or the like. Thus, even when the rake angle of the cutting edge of the shaving die is 40 to 50 degrees, a crack of the cutting edge can be suppressed. However, in a case where a steel wire material which is harder than copper or a copper alloy is shaved, there is a problem that a crack of the cutting edge cannot be suppressed due to an influence of the remaining scale after rolling or an uneven part of the surface. Further, when a crack is generated in the cutting edge, a processing mark (cutting mark) remains on the surface of the wire material, and processing force (cutting force) acting on the cutting edge is increased. Thus, there is a problem that the cutting edge are remarkably progressively worn away and a life span as the shaving tool is shortened. In addition, since this technique focuses on a countermeasure against wear of the cutting edge, smoothness of the cut surface after shaving is not considered at all.

An object of the present invention is to provide a shaving tool in which although with a simple configuration, a crack and wear of a cutting edge are suppressed and a life span is excellent, and a steel wire material shaving method capable of ensuring smoothness of a surface of a steel wire material by using this tool.

### Means for Solving the Problems

In order to achieve this object, the present invention is a shaving tool including a shaving die for shaving a surface layer of a steel wire material, wherein a cutting edge of the shaving die is made of any material out of cemented carbide, high speed tool steel, and ceramic, and in accordance with a predetermined shaving amount by which the surface layer of the steel wire material is shaved, surface roughness of the steel wire material allowable after shaving, and a predetermined life span required of the cutting edge, a rake angle θ_{S} of the cutting edge is formed within a range of −30 degrees or more and 0 degree or less.

Preferably, the rake angle θ_{S} of the cutting edge is −30 degrees or more and −2 degrees or less.

Preferably, the rake angle θ_{S} of the cutting edge is −30 degrees or more and −5 degrees or less.

Preferably, a relief angle θ_{N} of the cutting edge is 0 degree or more and 5 degrees or less.

Preferably, the plurality of shaving dies is installed in the feeding direction of the steel wire material, and formed in such a manner that an axis is common for the plurality of shaving dies, and an internal diameter d of the cutting edges of the plurality of shaving dies is gradually reduced toward the feeding direction of the steel wire material.

The present invention is a steel wire material shaving method of shaving a surface layer of a steel wire material using the above tool, wherein the cutting edge of the shaving die is controlled to cut in the surface layer of the steel wire material by a predetermined amount in such a manner that the surface roughness after shaving the surface layer of the steel wire material is an allowable value or less and the predetermined life span required of the cutting edge of the shaving die is satisfied.

### Effects of the Invention

As described above, the shaving tool according to the present invention is the shaving tool including the shaving die for shaving the surface layer of the steel wire material, wherein the cutting edge of this shaving die is made of any material out of cemented carbide, high speed tool steel, and ceramic, and in accordance with the predetermined shaving amount by which the surface layer of the steel wire material is shaved, the surface roughness of the steel wire material allowable after shaving, and the predetermined life span required of the cutting edge, the rake angle θ_{S} of the cutting edge is formed within a range of −30 degrees or more and 0 degree or less.

Thereby, the present invention can provide the shaving tool in which although with such a simple configuration that there is no need for installing a forced cooling device for cooling the cutting edge, a crack and wear of the cutting edge are suppressed and a life span required of the cutting edge is excellent. In addition, since the rake angle θ_{S} of the cutting edge is formed to be an angle within a range from zero to a negative value, cutting component force at the time of shaving (that is, force toward the perpendicular direction (normal direction) with respect to the feeding direction of the steel wire material) acts toward the axial direction of the shaving die. This works as a kind of centering action for the steel wire material. Thus, vibration of the steel wire material at the time of shaving is suppressed, and the uneven part of the steel wire material after shaving is decreased. From this point, an effect of suppressing generation of a crack of the cutting edge is also improved. As a matter of course, the decrease in the uneven part also has an advantage from a point of ensuring smoothness of a surface of the steel wire material after shaving.

The shaving method according to the present invention is the shaving method of shaving the surface layer of the steel wire material using the above shaving tool, wherein the cutting edge of the shaving die is controlled to cut in the surface layer of the steel wire material by the predetermined amount in such a manner that the surface roughness after shaving the surface layer of the steel wire material is the allowable value or less and the predetermined life span required of the cutting edge of the shaving die is satisfied.

Thereby, smoothness of the surface of the steel wire material can also be ensured. In particular, in a case where shaving is performed by using the shaving tool in which the plurality of shaving dies is installed in the feeding direction of the steel wire material, and formed in such a manner that the axis is common for the plurality of shaving dies, and the internal diameter d of the cutting edges of the plurality of shaving dies is gradually reduced toward the feeding direction of the steel wire material, remarkable work efficiency is provided. This is because in a case where such a shaving tool is used, smoothness of the surface of the steel wire material can be ensured and in addition, a predetermined large shaving amount by which the surface layer of the steel wire material is shaved can be ensured only by letting the steel wire material pass through the shaving tool just once at high feeding speed.

### BRIEF DESCRIPTION OF DRAWINGS

FIG. 1 is a schematic view for illustrating a state where a steel wire material is being shaved by a shaving die provided in a shaving tool of the present invention.

FIG. 2 is a schematic view for illustrating configurations of parts of a cutting edge of the shaving die in FIG. 1.

FIG. 3 is a schematic graph for illustrating a relationship between a rake angle θ_{S} of the cutting edge of the shaving die in FIG. 1 and an allowable value of arithmetic average roughness Ra of a surface after shaving a surface layer of the steel wire material.

### DESCRIPTION OF EMBODIMENTS

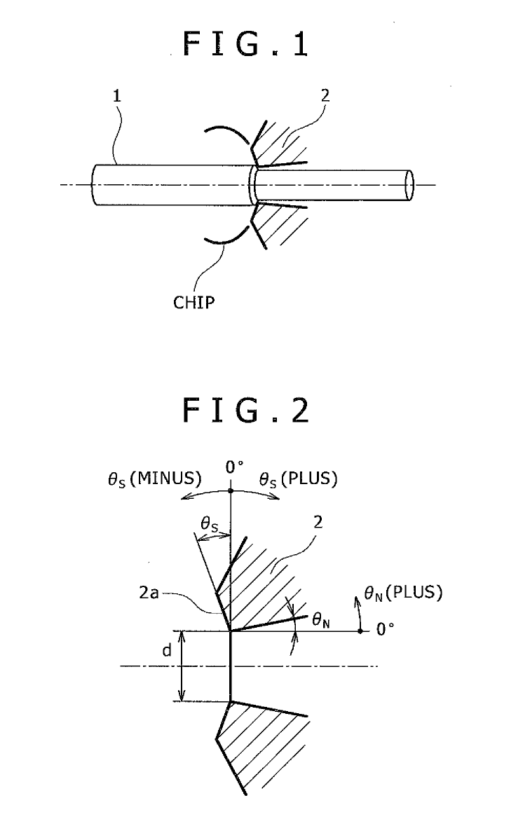

FIG. 1 is a schematic view for illustrating a state where a steel wire material is being shaved by a shaving die provided in a shaving tool of the present invention. In FIG. 1, the reference numeral 1 denotes a wire material made of steel (hereinafter, referred to as the “steel wire material”), and the reference numeral 2 denotes a shaving die provided in a shaving tool. In FIG. 1, by letting the steel wire material 1 pass through the shaving die 2 from the left side on the paper plane toward the right side, a surface layer of the steel wire material 1 can be shaved by a predetermined amount while generating chips from the surface layer of the steel wire material 1.

FIG. 2 is a schematic view for illustrating configurations of parts of a cutting edge 2a of the shaving die 2 shown in FIG. 1. In FIG. 2, the reference sign θ_{S} denotes a rake angle, and the reference sign θ_{N} denotes a relief angle. The positive (plus) direction and the negative (minus) direction of the rake angle θ_{S} and the relief angle θ_{N} are defined as shown in FIG. 2. The reference sign d denotes an internal diameter of the cutting edge 2a of the shaving die 2.

The present invention provides the shaving tool including the shaving die 2 in which a predetermined shaving amount by which the surface layer of the steel wire material 1 is shaved is ensured, smoothness of the surface of the steel wire material 1 is ensured, a crack and wear of the cutting edge 2a are suppressed, and a life span is excellent. For this, as a material of the cutting edge 2a of the shaving die 2, any of cemented carbide, high speed tool steel, and ceramic is favorable.

Conditions under which with the surface layer of the steel wire material 1 having an outer diameter of φ8 mm and Vickers hardness Hv=230, surface roughness (arithmetic average roughness) Ra after shaving the surface layer of the steel wire material 1 is an allowable value (about 0.4 μm) or less were examined. In order to find the conditions, the rake angle θ_{S} of the cutting edge 2a made of cemented carbide of the shaving die 2 was changed within a range from 5 degrees to −30 degrees as shown in Table 1 below, and a shaving amount by which the surface layer of the steel wire material 1 is shaved was changed within a range of 10 μm or more and 100 μm or less. That is, to match the outer diameter of the steel wire material 1 and the shaving amount, the internal diameter d of the cutting edge 2a of the shaving die 2 was controlled. As shown in FIG. 1, a shaving experiment was performed by letting the steel wire material 1 pass through the shaving die 2 at feeding speed of 80 m/min from the left side on the paper plane toward the right side. It should be noted that the relief angle θ_{N} was 2.5 degrees.

TABLE 1

| Shaving | | | | | | | |
|---|---|---|---|---|---|---|---|
| amount | Rake angle θs (degree) | | | | | | |
| (μm) | −30 | −20 | −10 | −5 | −2 | 0 | 5 |
| 100 | x | x | x | x | x | x | x |
| 60 | ∘ | x | x | x | x | x | x |
| 40 | ∘ | ∘ | ∘ | ∘ | x | x | x |
| 20 | ∘ | ∘ | ∘ | ∘ | ∘ | x | x |
| 10 | ∘ | ∘ | ∘ | ∘ | ∘ | ∘ | x |

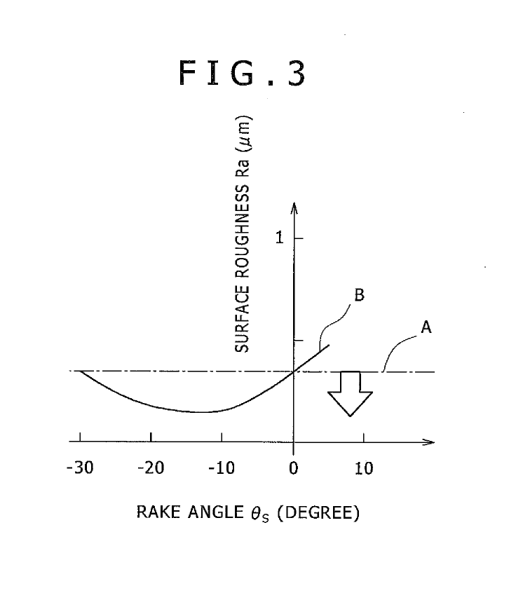

As a result, for example, in a case where the shaving amount by which the surface layer of the steel wire material 1 was shaved is set to be 10 μm, as shown in FIG. 3, a measured value of the arithmetic average roughness Ra shown by a line B to satisfy the allowable value of the arithmetic average roughness Ra (refer to a line A) was obtained with the rake angle θ_{S} within a range of −30 degrees or more and 0 degree or less. In particular, when the rake angle θ_{S} is around −15 degrees, the arithmetic average roughness Ra indicates the most preferable value.

As a result of the above experiment, in a case where the shaving amount is set to be 10 μm, the allowable value of the arithmetic average roughness Ra can be satisfied with the rake angle θ_{S} within a range of −30 degrees or more and 0 degree or less. At the same time, although with such a simple configuration that there is no need for installing a forced cooling device for cooling the cutting edge 2a, a crack and wear of the cutting edge 2a can be suppressed. That is, a predetermined life span (tool life span) required of the cutting edge is excellent. It should be noted that in Table 1 above, the symbol ∘ indicates satisfaction of both the conditions, and the symbol x indicates non-satisfaction.

In a case where the shaving amount is set to be 20 μm, an experiment result that both the conditions are satisfied with the rake angle θ_{S} within a range of −30 degrees or more and −2 degrees or less was obtained.

In a case where the shaving amount is set to be 40 μm, an experiment result that both the conditions are satisfied with the rake angle θ_{S} within a range of −30 degrees or more and −5 degrees or less was obtained.

In a case where the shaving amount is set to be 60 μm, an experiment result that both the conditions are satisfied only with the rake angle θ_{S} of −30 degrees was obtained.

In a case where the shaving amount is set to be 100 μm, an experiment result that both the conditions are not satisfied with any rake angle θ_{S} was obtained.

It is thought that both the conditions can be satisfied in a wide region as indicated by the symbol ∘ of Table 1 above due to the fact that the rake angle θ_{S} of the cutting edge 2a is formed within a range from zero to a negative value. When the rake angle θ_{S} of the cutting edge 2a is formed to be such an angle, cutting component force at the time of shaving (that is, force toward the perpendicular direction (normal direction) with respect to the feeding direction of the steel wire material 1) acts toward the axial direction of the shaving die 2. This works as a kind of centering action for the steel wire material 1. Thus, vibration of the steel wire material 1 at the time of shaving is suppressed, and an uneven part of the steel wire material 1 after shaving is decreased. From this point, it is thought that an effect of suppressing generation of a crack of the cutting edge 2a is also improved. As a matter of course, the decrease in the uneven part also has an advantage from a point of ensuring smoothness of a surface of the steel wire material 1 after shaving. As described above, since the shaving amount by which both the conditions can be satisfied covers a wide range, work efficiency to achieve a predetermined large shaving amount is improved.

It should be noted that in the above experiment, a case where cemented carbide is used as the material of the cutting edge 2a of the shaving die 2 is described. However, the present invention is not limited to this. High speed tool steel and ceramic are also favorable as the material of the cutting edge 2a of the shaving die 2, and the same result as the above experiment (result to satisfy both the conditions) can be obtained. In the above experiment, a case where the relief angle θ_{N} of the cutting edge 2a of the shaving die 2 is 2.5 degrees is described. However, the present invention is not limited to this. When the relief angle θ_{N} is within a range of 0 degree or more and 5 degrees or less, the equal result to the above experiment (result to satisfy both the conditions) can be obtained. In the above experiment, a case where the outer diameter of the steel wire material 1 is φ8 mm is described. However, the present invention is not limited to this. The invention of this application can be applied when the outer diameter of the steel wire material 1 is within a range of φ0.5 mm or more and φ1,000 mm or less. In the above experiment, a case where the feeding speed of the steel wire material 1 is 80 m/min is described. However, the present invention is not limited to this. The invention of this application can be applied when the feeding speed of the steel wire material 1 is within a range of 10 m/min or more and 200 m/min or less.

In the above experiment, a case where the shaving tool in which only one shaving die 2 is installed in the feeding direction of the steel wire material 1 at the time of shaving as shown in FIG. 1 is described. However, the present invention is not limited to this. For example, a shaving tool in which a plurality of shaving dies 2 formed in such a manner that an axis is common for the shaving dies is installed in the feeding direction of the steel wire material 1 and an internal diameter d of cutting edges 2a of the plurality of shaving dies 2 is gradually reduced toward the feeding direction of the steel wire material 1 can be used. In a case where shaving is performed by using such a shaving tool, smoothness of the surface of the steel wire material 1 can be ensured. Further, only by letting the steel wire material 1 pass through the shaving tool just once at high feeding speed, a predetermined large shaving amount by which the surface layer of the steel wire material 1 is shaved can be ensured. Thus, remarkable work efficiency is provided.

It should be noted that the embodiment disclosed herein is thought to be not a limitation but an example in all respects. In particular, regarding matters not explicitly disclosed in the embodiment disclosed herein such as an operation condition, a production condition, various parameters, size of constituent parts, weight, and volume, values not departing from a range that those skilled in the art generally implement, the values easily anticipated by those skilled in the art in general are adopted. The present application is based on the Japanese Patent application (Japanese Patent Application No. 2013-033204) filed in Feb. 22, 2013, and contents thereof are taken herein as a reference.

### EXPLANATION OF REFERENCE NUMERALS

1: Steel wire material
2: Shaving die
2a: Cutting edge
θ_{S}: Rake angle
θ_{N}: Relief angle
d: Internal diameter of cutting edge

1. A shaving tool comprising a shaving die for shaving a surface layer of a steel wire material, wherein:
a cutting edge of the shaving die is made of any material out of cemented carbide, high speed tool steel, and ceramic; and
in accordance with a predetermined shaving amount by which the surface layer of the steel wire material is shaved, surface roughness of the steel wire material allowable after shaving, and a predetermined life span required of the cutting edge, a rake angle θ_{S} of the cutting edge is formed within a range of −30 degrees or more and 0 degree or less.

2. The shaving tool according to claim 1, wherein:
the rake angle θ_{S} of the cutting edge is −30 degrees or more and −2 degrees or less.

3. The shaving tool according to claim 1, wherein:
the rake angle θ_{S} of the cutting edge is −30 degrees or more and −5 degrees or less.

4. The shaving tool according to claim 1, wherein:
a relief angle θ_{N} of the cutting edge is 0 degree or more and 5 degrees or less.

5. The shaving tool according to claim 1, wherein:
the plurality of shaving dies is installed in the feeding direction of the steel wire material, and formed in such a manner that an axis is common for the plurality of shaving dies; and
an internal diameter d of the cutting edges of the plurality of shaving dies is gradually reduced toward the feeding direction of the steel wire material.

6. A steel wire material shaving method of shaving a surface layer of a steel wire material using the shaving tool according to any one of claims 1 to 5, wherein:
the cutting edge of the shaving die is controlled to cut in the surface layer of the steel wire material by a predetermined amount in such a manner that the surface roughness after shaving the surface layer of the steel wire material is an allowable value or less and the predetermined life span required of the cutting edge of the shaving die is satisfied.
